(19) United States
(12) Patent Application Publication
(10) Pub. No.: US 2023/0372927 A1
(43) Pub. Date: Nov. 23, 2023

(54) MICRO-FLUIDIC CARTRIDGE

(71) Applicant: ASELSAN ELEKTRONIK SANAYI VE TICARET ANONIM SIRKETI, Ankara (TR)

(72) Inventors: Mustafa YORULMAZ, Istanbul (TR); Akif Turker GURER, Ankara (TR); Can Burak TARHAN, Ankara (TR); Mustafa Tuncer OZTURK, Ankara (TR); Husnu Can DOGRU, Ankara (TR); Didem Lale OZKAN, Istanbul (TR)

(73) Assignee: ASELSAN ELEKTRONIK SANAYI VE TICARET ANONIM SIRKETI, Ankara (TR)

(21) Appl. No.: 18/245,358

(22) PCT Filed: Dec. 15, 2020
(86) PCT No.: PCT/TR2020/051303

§ 371 Date: Mar. 15, 2023

(30) Foreign Application Priority Data
Oct. 12, 2020 (TR) 2020/16236

(51) Int. Cl. B01L 3/00

(52) U.S. Cl. CPC B01L 3/502707; B01L 3/502746; B01L 2300/022; B01L 2300/0636; B01L 2300/069; B01L 2300/0877

(57) ABSTRACT

A micro-fluidic cartridge enables analysis of biological samples of fluid form particularly by means of optical systems. The micro-fluid cartridge includes a body, at least one fluid inlet located on the body, at least one channel connected to fluid inlet from one end and allowing flow of fluid there through, at least one first chamber arranged in a fluid communication with channel on the body, at least one biological chip located inside the first chamber and structured to keep certain components inside the fluid, at least one cover connected to the body in a manner preventing leakage of liquid from channel to outer environment on the body and having light penetration on part corresponding to at least biological chip.

### CROSS REFERENCE TO THE RELATED APPLICATIONS

This application is the national phase entry of International Application No. PCT/TR2020/051303, filed on Dec. 15, 2020, which is based upon and claims priority to Turkish Patent Application No. 2020/16236, filed on Oct. 12, 2020, the entire contents of which are incorporated herein by reference.

### TECHNICAL FIELD

This invention relates to a micro-fluidic cartridge enabling analysis of biological samples of fluid form particularly by means of optical systems.

### BACKGROUND

Today, micro-fluidic cartridges providing analysis of biological samples by passing through and delivering the biological samples through a channel that is fluidically coupled to an analysis chamber in which a biological chip specifically developed to hold components such as protein, molecules contained in the sample, intended to be analysed can be housed has been commonly used. Design and production of said cartridges were started in 1990s and various designs have been made in the prior art up to now. However, when cartridges of the prior art are observed, it is seen that no development has been made in cartridge designs in view of keeping the speed of the samples taken into the channel at certain levels. Due to the relatively high speed of the sample on the biological chip, the components in the sample cannot be hold effectively by the biological sensor, thereby the analysis performed via the cartridge could not be as accurate as desired. In addition, in the cartridge of the prior art, the sample taken inside the cartridge is discharged outside of the cartridge after being analysed which can result in adverse non-hygienic conditions for the environment.

International patent document numbered WO0145843 in the prior art relates to a cartridge comprising a base including multiple number of channels, a housing formed on the base, a biological chip placed inside the housing preferably by means of a biological chip holder and a glass covering the top of the biological chip. In the disclosed cartridge, the sample is first reached to chip holder through a hole located on the base and thereafter to chip. This situation causes a failure in controlling the speed of the sample incoming to the biological sensor and thereby a reduction in the accuracy of the analysis performed on the sample due to the decreased performance of the biological chip.

A European patent document numbered EP1161989 in the prior art relates to a cartridge in which a biological chip is embedded onto a base. Embedding the biological chip directly onto the base without using any chip holder causes limitation in surface activation operation of biological chip and thus a restriction in usability of cartridge in specific applications.

Therefore, there is a need for providing a micro-fluidic cartridge that enables keeping the speed of the sample at certain levels and preventing the discharge of the analysed sample into the outer environment.

### SUMMARY

The aim of the present invention is to realize a micro-fluidic cartridge enabling analysis of fluidic biological samples particularly by means of optical systems.

The micro-fluidic cartridge realized in order to attain the aim of the present invention, explicated in the first claim and the respective claims thereof comprises a body, at least one fluid inlet located on the body, at least one channel arranged on the body so as to be connected to the fluid inlet by one of its ends and allowing flow of fluid through it, at least one first chamber arranged on the body so as to be in fluidic communication with the channel, at least one biological chip placed inside the first room and configured to hold at least one predetermined component of the fluidic biological sample and at least one cover connected to the body such that it prevents the fluidic communication of the body and the environment in a fluid-tight manner and at least a portion of which corresponding to the biological chip has a light-transmitting structure wherein the micro-fluidic cartridge further comprises at least one inclined region arranged inside the channel extending substantially from fluid inlet to first chamber such that it forms a ramp by raising from the fluid inlet to the first chamber. By virtue of inclined region provided inside the channel, speed of fluid entering to the channel via fluid inlet decreases while passing through the inclined region and thus flow rate of sample given into the micro-fluidic cartridge is kept under control, thereby reliable operation of the biological chip is provided.

### BRIEF DESCRIPTION OF THE DRAWINGS

The micro-fluidic cartridge realized to achieve the aim of the present invention is illustrated in the accompanying drawings, wherein;

FIG. 1 is a perspective view of an embodiment of the micro-fluidic cartridge of the invention.

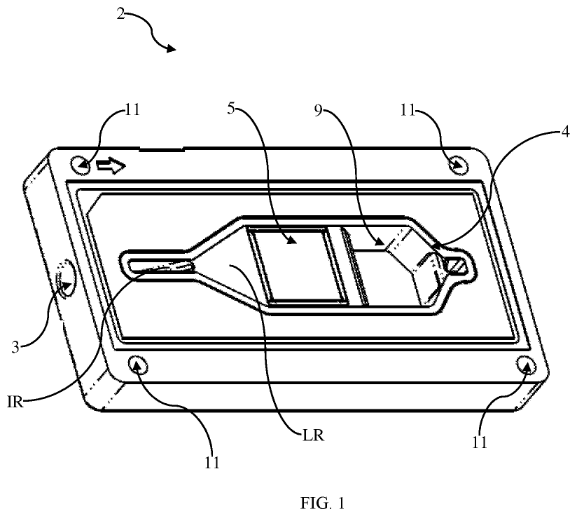

FIG. 2 is an exploded perspective view of an embodiment of the micro-fluidic cartridge of the invention.

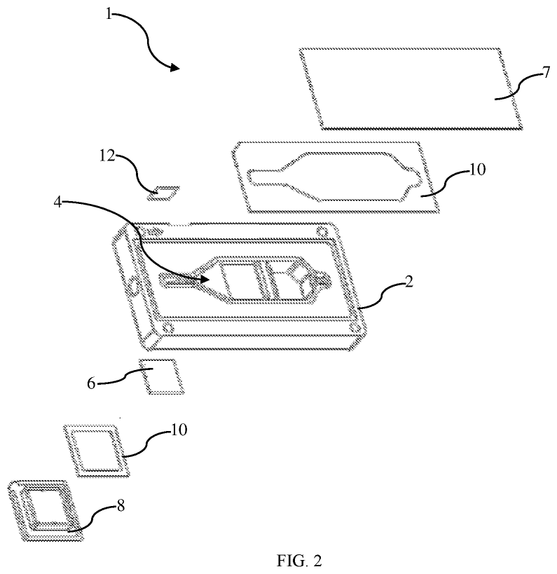

FIG. 3 is a cross-sectional view of an embodiment of the micro-fluidic cartridge of the invention.

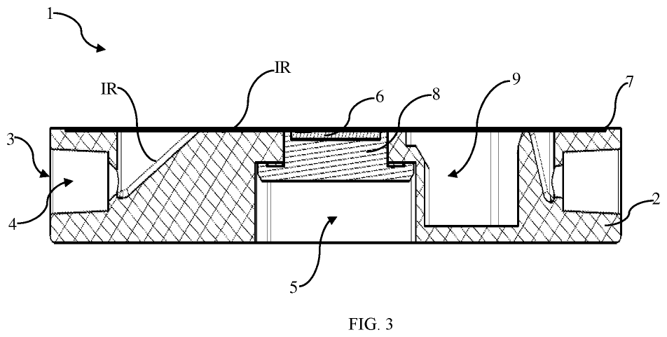

The elements in the figures are numbered individually and the correspondence of these numbers are given hereinafter:
1. Micro-fluidic cartridge
2. Body
3. Fluid inlet
4. Channel
5. First chamber
6. Biological chip
7. Cover
8. Chip holder
9. Second chamber
10. Double-sided tape
11. Connection holes
12. Tag
IR. Inclined region
LR. Linear region

### DETAILED DESCRIPTION OF THE EMBODIMENTS

The micro-fluidic cartridge (1) comprises; a body (2), at least one fluid inlet (3) located on the body (2), at least one channel (4) connected to the fluid inlet (3) from one end thereof and allowing fluid flow there through, at least one first chamber (5) arranged on the body (2) so as to be in a fluidic communication with the channel (4), at least one biological chip (6) placed inside the first chamber (5) and configured to hold predetermined components inside the fluid and at least one cover (7) connected to the body (2) such that it prevents the fluidic communication between the channel (4) and the outer environment in a fluid-tight manner and at least a portion of which corresponding to the biological chip (6) has a light-transmitting structure. When it is intended to analyse a sample by using the micro-fluidic cartridge (1), fluid preferably in liquid form is fed into channel (4) through fluid inlet (3), it progresses inside channel (4) and fills into first chamber (5) and contacts biological chip (6) placed in the first chamber (5). When the fluid contacts biological chip (6), the biological chip (6) configured to hold predetermined components such as molecules, proteins holds said components. Then biological chip (6) is examined by optical system such as microscope and analysis of whether or not the corresponding component is held and therefore analysis of sample is made. In a preferred embodiment of the invention, the body (2) is preferably of a prismatic shape and made from an acrylic material. The channel (4) preferably extends from one end of the body (2) to other end opposite to that end. Since the biological chip (6) is examined by means of an optical system such as microscope, when cover (7) is placed onto body (2), particularly part of cover (7) corresponding onto the biological chip (6) is selected in such a manner that it will not create background image in optical imaging and increase background signal and decrease accuracy and related cover (7) part is preferably glass made from COC, BK-7, ITO, Boro Silicate or polymer materials such as PMMA, PDMS, acrylic. In an embodiment of the invention, cover (7) has a thickness selected in the range of 0.13 mm-0.19 mm and in a more preferable embodiment of the invention, it has a thickness selected from range of 0.13 mm-0.16 mm. In a preferred embodiment of the invention, height of the channel (4), i.e. the distance between the bottom of channel (4) and the surface of the cover (7) facing to the body (2) is equal to 0.07 mm or smaller and in a more preferable embodiment of the invention, it equals to 35 μm±5 μm. Thus, it offers a precise and reliable conduct of analysis by the optical system.

The channel (4) provided in the micro-fluidic cartridge (1) of the present invention comprises at least one inclined region (IR) extending substantially from the fluid inlet (3) to the first chamber (5) such that it raises from the fluid inlet (3) to the first chamber (5). By virtue of the inclined region (IR) arranged inside the channel (4), the speed of fluid entering channel (4) via fluid inlet (3) is decreased while passing through the inclined region (IR) and thus flow rate of sample given into micro-fluidic cartridge (1) is taken under control and so more reliable operation of biological chip (6) is provided. In addition, by eliminating the high flow rate of fluid inside the channel (4) occurrence of any leakage problem between body (2) and cover (7) where the pressure likely to be relatively high due to high flow rate of fluid or damages to the cover (7) is prevented.

In an embodiment of the invention, the channel (4) further comprises at least one linear region (LR) almost linearly extending between an end of the inclined region (IR) which is positioned on the opposite side of the fluid inlet (3) and the first chamber (5). By this way, flow of fluid flowing through the inclined region (IR) develops in linear region (LR) and allows formation of a more homogenous flow profile on the biological chip (6). Thus, it is provided that the biological chip (6) operates more precisely.

In an embodiment of the invention, the micro-fluidic cartridge (1) further comprises at least one chip holder (8) placed inside the first chamber (5) and enabling holding of the biological chip (6). Chip holder (8) has a frame form of a certain geometric shape such as square, rectangular allowing placement of biological chip (6) almost in the centre thereof. Thus, placement of biological chip (6) inside first chamber (5) by means of a chip holder (8) is provided instead of placing the said biological chip (6) directly into the first chamber (5) and thus no limitation of surface action operations of biological chip (6) is required and easy mounting is provided.

In an embodiment of the invention, the micro-fluidic cartridge (1) further comprises at least one fluid outlet (not shown in figures) arranged on the body (2) so as to be in fluidic communication with the channel (4) and enabling discharging of fluid passing through the first chamber (5) from the body (2). In a preferred embodiment of the invention, the fluid outlet is located on a surface opposite to the surface in which the fluid inlet (3) is located on the body (2). Thus, after the fluid given into the channel (4) by means of the fluid inlet (3) passes through the first chamber (5), it is discharged from the body (2) by means of the fluid outlet.

In an embodiment of the invention, the micro-fluidic cartridge (1) further comprises at least one second chamber (9) arranged on the body (2) such that it is in fluidic communication with the channel (4) and configured to allow accumulation of at least an amount of fluid passing from the first chamber (5) therein. In this embodiment, discharging the fluid that has passed the first chamber (5) out of the body (2) is at least partially eliminated by the accumulation of that fluid inside the second chamber (9). Thus elimination of deformation of hygiene level of surrounding medium of the micro-fluidic cartridge (1) is provided.

In an embodiment of the invention, the micro-fluidic cartridge (1) further comprises at least one absorbing material (not shown in figures) placed inside the second chamber (9) and having a suitable structure for absorbing the fluid entering into the second chamber (9). By this way, without need for increase in an inner volume of second chamber (9) and therefore, body (2) and micro-fluidic cartridge (1) size, some part of fluid entering inside second chamber (9) is absorbed by the absorbing material and it is provided to keep more fluid by second chamber (9) and absorbing material.

In an embodiment of the invention, the cover (7) is connected to the body (2) by use of a glue material. By this way, the desired fluid sealing of the channel (4) is provided.

In a preferred embodiment of the invention, the cover (7) is connected to the body (2) by use of a double-sided tape (10) which is adhered to the cover (7) from one surface thereof and to the body (2) from the other surface. By using the double-sided tape (10) saving in workforce and assembly time during assembly is provided.

In a preferred embodiment of the invention, the cover (7) is connected to body (2) by use of at least a fluid glue. Said embodiment enables strong connection between cover (7) and body (2).

In the embodiment of the invention in which the cover (7) is connected to the body (2) by use of fluid glue, the body (2) comprises at least one groove (not shown in figures) enabling taking the fluid glue there inside. Said groove preferably extends on the body (2) and more specifically on the surface of the body (2) facing the cover (7) in a manner to surround channel (4). In this embodiment, prior to association of the body (2) and the cover (7), the fluid glue is applied to said groove and the cover (7) is pressed onto the body (2) so that the interconnection is provided. Thus, escape of the glue into the channel (4) and therefore air bubble formation inside the channel (4) during adhering cover (7) and body (2) are prevented.

In an embodiment of the invention, the micro-fluidic cartridge (1) further comprises at least one glue escape channel (not shown in figures) which is in fluidic communication with the groove and extending from groove to the inside of the body (2). With help of said glue escape channel, in case of an excess glue supply into the groove, excess amount of the glue enters into the escape channel and thus formation of air bubbles, which destroys the preciseness of the optical imaging during analysis, inside the channel (4) is eliminated. In addition, said escape channel also enables keeping level of glue inside the groove at predetermined quantity and thus prevents use of glue in different quantities at various micro-fluidic cartridges (1) and thus keeping the distance between the cover (7) and the biological chip (6) at same amount all the times are provided. Thus same analysis preciseness can be achieved in analysis of samples at different micro-fluidic cartridges (1).

In a preferred embodiment of the invention, the micro-fluidic cartridge (1) further comprises at least one connection hole (11) provided on the body (2) for connection of the body (2) to an optical system performing the sample analysis. Said micro-fluidic cartridge (1) seats onto required spaces provided for seat of the cartridge (1) in an optical system such as microscope, for instance, by the help of the connection hole (11) provided on the body (2) and this case allows performance of sample analysis in a more accurate way. In an embodiment of the invention, the body (2) contains multiple connection holes (11) and at least one of such connection holes (11) on the body (2) is arranged to be offset in respect to others. Thus, mis-installation of the body (2) to the optical system is prevented and conduct of faulty analysis is prevented.

In an embodiment of the invention, the micro-fluidic cartridge (1) further comprises at least one tag (12) provided on the body (2) and containing at least a definitive information on the sample to be taken into the body (2). In an embodiment of the invention, said sample information can be printed on the tag (12) as well as in alternative embodiments, it may also have a code form such as barcode, square code etc. which can be read by means of an electronic reader. Thus, any confusion concerning sample analysed by the use of micro-fluidic cartridge (1) is prevented.

This invention also relates to a method for assembling the micro-fluidic cartridge (1) of the type described above and said assembly method for micro-fluidic cartridge (1) comprises the steps of:
providing a body (2) at leastly comprising at least one fluid inlet (3), at least one channel (4) and at least one first chamber (5) having a through hole form,
connection of at least one cover (7) to the body (2),
integrating at least one biological chip (6) to the chip holder (8) and
connection of the chip holder (8) integrated with the biological chip (6) to the body (2) through insertion into the body (2) from the opening that is not facing to the cover (7) of the first chamber (5).

In the assembly method of the micro-fluidic cartridge (1) of the invention, the cover (7) is connected to the body (2) by use of at least a glue. In a preferred embodiment of the invention, the cover (7) is combined with the body (2) by use of a plane double-sided tape (10) adhered to cover (7) from one surface and to the body (2) from other surface. Said embodiment of the invention also comprises at least one guide corresponding to a predefined region where double-sided tape (10) is fixed onto at least one of the body (2) or cover (7) so as to place double-sided tape (10) accurately. Thus, during assembly faulty application of the double-sided tape (10) is prevented and it is provided that the double-sided tape (10) could be applied even by an inexperienced person. In another embodiment of the invention, the cover (7) is fixed to the body (2) by use of a liquid glue. In such an embodiment, liquid glue is filled into a groove extending on the body (2) and the connection between the cover (7) and the body (2) is provided by pressing the cover (7) onto the body (2).

In the assembly method of the micro-fluidic cartridge (1) of the invention, the biological chip (6) is connected to the chip holder (8) by use of at least a glue. In a preferred embodiment of the invention, the biological chip (6) is connected to the chip holder (8) by use of a liquid glue. In an alternative embodiment of the invention, the biological chip (6) is connected to the chip holder (8) by use of a double-sided tape (10). Said embodiment of the invention also comprises at least one guide corresponding to a predefined region where double-sided tape (10) is fixed onto at least one of the biological chip (6) or chip holder (8) so as to place double-sided tape (10) accurately. Thus, during assembly faulty application of the double-sided tape (10) is prevented and it is provided that the double-sided tape (10) could be applied even by an inexperienced person.

In the assembly method of the micro-fluidic cartridge (1) of the invention, the biological chip (6) integrated chip holder (8) is inserted into the body (2) from the opposite side of the surface which is facing the cover (7) of the first chamber (5) having a through hole form and connected to the body (2) preferably by means of a glue. In a preferred embodiment of the invention, process of at least fixing chip holder (8) to the body (2) and moreover fixing biological chip (6) to the chip holder (8) and connection of a chip holder (8) having biological chip (6) thereon, onto the body (2) are all performed by related persons such as technicians in the place where the micro-fluid cartridge (1) is used for supplying sample into the channel. In this embodiment, double-sided tape (10) is fixed onto the chip holder (8) whereon biological chip (6) is fixed and the chip holder (8) is passed through corresponding opening of the first chamber (5) and surface of the double-sided tape (10) not fixed to chip holder (8) is fixed to the body (2) and thus integration of chip holder (8) and therefore, the biological chip (6) to the body (2) is provided and micro-fluidic cartridge (1) is made ready for use. By virtue of integrating the chip holder (8) to the body (2) in application side before taking sample into the micro-fluidic cartridge (1) logistic advantages are achieved and thereby safer transportation of biological chips (6) is provided and risks of exposure to damage is minimized. Moreover, as biological chips (6) are of structure affected by temperature, said biological chips (6) can be kept at certain temperature ranges providing elimination of risk of damages during carrying and storing thereof.

Fluid entrance speed of fluid supplied into the channel (4) via the fluid inlet (3) is slowed down thanks to the inclined region (IR) arranged in almost entrance part of channel (4) in micro-fluidic cartridge (1) and by this way it is provided that the biological chip (6) performs its function as well as possible and therefore, reliable performance of sample analysis performed by preferably an external optical system is offered. In addition to this, risk of damage to cover (7) or fluid-tightness provided between the cover (7) and the body (2) caused by high flow rate is prevented by means of keeping flow rate of the fluid flowing inside the channel (4) at a certain level. In addition, by preventing the discharge of at least a major amount of the sample used for analysis process from the body (2) by means of accumulation of sample inside the second chamber (9) and on the absorbing material by the help of the second chamber (9) provided on the body (2) of the micro-fluidic cartridge (1) and further by the absorbing material arranged inside the secondary chamber (11), an adverse impact of medium around the micro-fluidic cartridge (1) on hygiene level is eliminated.

Within these basic concepts; it is possible to develop various embodiments of the inventive micro-fluidic cartridge (1); the invention cannot be limited to examples disclosed herein and it is essentially according to claims.

What is claimed is:

1. A micro-fluidic cartridge, comprising:
a body,
at least one fluid inlet located on the body,
at least one channel connected to the fluid inlet from one end thereof and allowing fluid flow there through,
at least one first chamber arranged on the body to be in a fluidic communication with the channel,
at least one biological chip placed inside the first chamber and configured to hold predetermined components inside the fluid, and
at least one cover connected to the body, wherein the cover prevents the fluidic communication between the channel and an outer environment in a fluid-tight manner and at least a portion of the cover corresponding to the biological chip has a light-transmitting structure;
wherein the channel comprises at least one inclined region extending substantially from the fluid inlet to the first chamber, such that the inclined region raises from the fluid inlet to the first chamber.

2. The micro-fluidic cartridge according to claim 1, wherein the channel comprises at least one linear region almost linearly extending between an end of the inclined region which is positioned on an opposite side of the fluid inlet and the first chamber.

3. The micro-fluidic cartridge according to claim 1, wherein characterized by at least one chip holder is placed inside the first chamber and enables holding of the biological chip.

4. The micro-fluidic cartridge according to claim 1, wherein at least one fluid outlet is arranged on the body to be in fluidic communication with the channel and enables removal of fluid passing through the first chamber from the body.

5. The micro-fluidic cartridge according to claim 1, wherein at least one second chamber is arranged on the body to be in fluidic communication with the channel and configured to allow accumulation of at least an amount of fluid passing from the first chamber therein.

6. The micro-fluidic cartridge according to claim 5, wherein at least one absorbing material is placed inside the second chamber and has a suitable structure for absorbing the fluid entering into the second chamber.

7. The micro-fluidic cartridge according to claim 1, wherein the cover which is connected to the body by use of a glue material.

8. The micro-fluidic cartridge according to claim 7, wherein the cover is connected to the body by use of a double-sided tape, wherein the double-sided tape is adhered to the cover from one surface thereof and to the body from the other surface.

9. The micro-fluidic cartridge according to claim 7, wherein the cover is connected to the body by use of at least a fluid glue.

10. The micro-fluidic cartridge according to claim 9, wherein the body comprises at least one groove enabling taking the fluid glue there inside.

11. The micro-fluidic cartridge according to claim wherein at least one glue escape channel is in fluidic communication with the groove and extends from the groove to an inside of the body.

12. The micro-fluidic cartridge according to claim 1, wherein at least one connection hole is provided on the body for connection of the body to an optical system performing a sample analysis.

13. The micro-fluidic cartridge according to claim 1, wherein at least one tag is provided on the body and contains at least a definitive information on a sample to be taken into the body.

14. A method for assembling the micro-fluidic cartridge according to claim 1, comprising steps of:
providing the body at least comprising the at least one fluid inlet, the at least one channel and the at least one first chamber having a through hole form,
connection of the at least one cover to the body,
integrating the at least one biological chip to a chip holder, and
connection of the chip holder integrated with the biological chip to the body through insertion into the body from an opening that is not facing to the cover of the first chamber.

15. The method according to claim 14, wherein the cover is connected to the body by use of at least a glue.

16. The method according to claim 14, wherein the biological chip is connected to the chip holder by use of at least a glue.

17. The method according to claim 14, wherein the biological chip integrated chip holder is inserted into the body from an opposite side of the surface which is facing the cover of the first chamber having a through hole form and connected to the body preferably by a glue.

18. The micro-fluidic cartridge according to claim 2, wherein at least one chip holder is placed inside the first chamber and enables holding of the biological chip.

19. The micro-fluidic cartridge according to claim 2, wherein at least one fluid outlet is arranged on the body to be in fluidic communication with the channel and enables removal of fluid passing through the first chamber from body.

20. The micro-fluidic cartridge according to claim 3, wherein at least one fluid outlet is arranged on the body to be in fluidic communication with the channel and enables removal of fluid passing through the first chamber from body.
